(19) United States
(12) Patent Application Publication
(10) Pub. No.: US 2021/0394304 A1
(43) Pub. Date: Dec. 23, 2021

(54) FIBER COUPLED LASER WITH VARIABLE BEAM PARAMETERS PRODUCT

(71) Applicant: II-VI Delaware, Inc, Wilmington, DE (US)

(72) Inventor: Haro Fritsche, Berlin (DE)

(21) Appl. No.: 17/304,315

(22) Filed: Jun. 17, 2021

(30) Foreign Application Priority Data
Jun. 19, 2020 (DE) 102020116268.5

(51) Int. Cl. B23K 26/06; B23K 26/073

(52) U.S. Cl. CPC B23K 26/0648; B23K 26/0006; B23K 26/0652; B23K 26/073

(57) ABSTRACT

The invention relates to an apparatus and method for varying the beam parameter product of diode lasers in laser material processing. The present invention provides an apparatus for laser material processing, comprising laser diodes as a laser source; a focusing lens; a fiber into which the light is coupled, wherein the beam parameter product of the fiber is greater than the beam parameter product of the incident laser light; and a substrate for producing an offset of the beam axis.

### BACKGROUND OF THE INVENTION

### Field of Invention

The invention relates to a device and a method for changing the beam parameter product in diode lasers used for laser material processing.

### Brief Description of the Related Art

Different types of lasers are usually required for material processing of different types of materials and thicknesses (e.g. CO₂-laser, multi-mode fiber lasers, single-mode fiber lasers, direct diode lasers). All these different lasers differ in the beam quality factor or beam parameter product of the generated laser beam. While single-mode fiber lasers are very good for cutting material <1 mm thick, material about 10 mm thickness requires a much higher beam parameter product of 5-10 mm mrad. For material thicknesses above 30 mm, CO₂ lasers are currently used.

Lasers with a good beam parameter product (also SPP or BPP) are used in laser material processing, especially for cutting or remote welding applications. Single-mode lasers in the wavelength range of 1 μm have poor cutting efficiency when it comes to cutting medium or thick materials, although they have high power. When cutting material, a so-called single-mode beam profile produces only a very thin cut that is not wide enough to eject the molten material in thicker materials. In addition, the cut piece often must be removed with a hammer and does not fall out because it is canted. In addition, the use of such a beam profile does not result in good cut edges in terms of squareness and surface roughness. The surface roughness results from interference in the cutting gap (like diffraction at the single slit). In areas with lower intensity, the melt cools faster.

For the reasons mentioned above, CO₂ lasers are therefore also used for larger material thicknesses, which have the same beam parameter product (measured by the diver-gence and the emitting area) but have a poorer beam quality factor (M2) due to the wavelength difference. In general, both beam parameter product and beam quality factor are fundamental parameters of a laser beam that cannot be changed during propagation. Therefore, the laser type must be adapted to the thickness of the materials to be processed.

Different solutions are known from the prior art, but all of them are based on multilayer fibers to shift the power from the central fiber core to outer layers. This creates a ring profile around the central spot of the laser.

The prior art also describes a solid-state laser for coupling into the center core or its first cladding.

### SUMMARY OF THE INVENTION

It is therefore an object of the present invention to provide a fiber-coupled diode laser with variable beam parameter product.

The presenting invention provides an apparatus for laser material processing comprising:

Laser diodes as a laser source;

A focusing lens;

A fiber into which the light is coupled, wherein the beam parameter product of the fiber is greater than the beam parameter product of the incident laser light; and

A substrate for creating an offset of the beam axis.

In a further embodiment of the apparatus, the substrate is parallel transparent, comprises multiple substrates of different thicknesses arranged side by side, or comprises a substrate having subunits of different refractive indices.

In another aspect of the invention, it is provided that the apparatus according to the present disclosure may comprise at least one rotatable deflection mirror as a substrate or in addition to a substrate.

In another embodiment, the substrate may be a zoom optic.

Furthermore, it may be provided that the substrate is a pair of plano-convex and concave lenses with identical radii of curvature.

In another aspect of the invention, the lens pair may comprise meniscus lenses.

In another embodiment, it is provided that the substrate is extended to combine birefringence optics with a rotatable half-wave plate.

According to the invention, the substrate may be located before or after the focusing lens, but before the fiber into which the laser light is coupled.

In another embodiment of the apparatus according to the present disclosure, the laser source may be a multi-wavelength laser and the substrate is a grating movable in the direction of the beam axis.

Furthermore, a plane-parallel substrate can additionally be arranged in the beam path in front of the grating.

Another object of the present invention is a method for increasing the coupling divergence to decrease the beam parameter product, comprising the steps of

a. Generating a laser beam with a diode laser;

b. Focusing of the laser beam with a focusing lens;

c. Coupling the laser beam into a fiber, changing the divergence, spot size, or angle of incidence of the laser beam using a substrate.

The method according to the present disclosure can also be designed that the fiber into which the laser steel is coupled has a higher beam parameter product than the incident laser light.

Other aspects, features and advantages of the present invention will readily be apparent from the following detailed description, which simply sets forth preferred embodiments and implementations. The present invention may also be realized in other and different embodiments, and its various details may be modified in various obvious aspects, without departing from the teachings and scope of the present invention. Accordingly, the drawings and descriptions are to be considered illustrative and not limiting. Additional purposes and advantages of the invention are set forth in part in the following description and will become apparent in part from the description or may be inferred from the embodiment of the invention.

### BRIEF DESCRIPTION OF THE FIGURES

The invention is illustrated in more detail below with reference to figures. It will be obvious to those skilled in the art that these are only possible, exemplary embodiments, without limiting the invention to the embodiments shown.

FIG. 1 shows the use of a parallel transparent substrate.

FIG. 2 shows the use of rotating deflection mirrors.

FIG. 3 shows the use of deflection mirrors to produce a false point determination.

FIG. 4 shows the use of zoom optics to focus into the fiber.

FIG. 5 shows the use of a pair of lenses (plano-convex and concave) with identical radius of curvature in front of the focusing lens.

FIG. 6 shows the use of the birefringence optics in combination with an adjustable half-wave plate (delay plate).

FIG. 7 Use of a rotatable (arrow) dispersive element with a multiple wavelength laser source.

FIG. 8 time the use of multi-wavelength lasers.

FIG. 9 shows the use of a plane-parallel substrate in the beam path.

FIG. 10 shows the summary of effects.

### DETAILED DESCRIPTION OF THE INVENTION

The previously formulated problem of the invention is solved by the features of the independent claims. The dependent claims cover further specific embodiments of the invention.

The invention is based on the approach of changing the divergence or spot size or angle of incidence of the beam at the fiber entrance to produce a true change in beam parameter product within the confines of the fiber or a ring in the core. Finally, the use of a multiple clad fiber can be used to create a ring around the central core while maintaining a homogeneous core light. In this way, the power distribution between the core and cladding can be adjusted in any ratio, even when multi-cladding fibers are used.

The minimum beam parameter product is defined by the basic properties of the diode laser and is therefore low enough to cut thin materials very well. However, by specifically changing the beam parameter product, this laser can also be used for all kinds of materials with optimized beam characteristics in terms of the beam parameter product or spot donut profile.

When the laser radiation is coupled into a light conducting optical system based on total internal reflection, such as a rod or fiber, the beam parameter product is usually reduced (higher BPP number=worse, reduced BPP) as the divergence remains constant but the emission area increases core area, or even the cladding area of the fiber. This means that the beam parameter product can be degraded by coupling into a fiber while maintaining divergence. This is also the case with diode lasers that are freely coupled into the fiber.

By using a fiber with a larger acceptance angle (NA) than that of the incident laser beam, the beam parameter product at the fiber exit can be reduced by increasing the incident angle divergence or the incident angle at the entrance side. Alternatively, multiple clad fibers can be used to further reduce the beam parameter product.

For example, an arrangement according to published U.S. patent application US 2015/0321286 Al, which describes a method to arrange multiple diode lasers (with different wavelengths) for different beam profiles in propagation in free space, can be used to couple into a fiber to produce different beam parameter products or beam shapes.

The present invention uses fibers that have a beam parameter product that is greater than the beam parameter product of the incident laser light. Various fiber couplings can be used to influence the beam parameter product at the fiber output, as well as the emission shape, which can be changed from spot to donut.

Theoretically, a laser with a beam parameter product of 1 mm mrad, for example, could be coupled into a 20 mm mrad fiber and the outgoing BPP would still be 1 mm mrad.

For equivalent values of beam diameter and fiber core diameter, the coupling divergence is much smaller than the acceptance angle of the fiber. By increasing the coupling divergence, the beam spot size typically decreases. However, since the fiber would homogenize the radiation, the fiber diameter at the fiber exit would emit the laser light while the divergence remains identical to the incoming laser radiation: The result is a decrease in the beam parameter product.

For example, a 10 mm mrad laser could be coupled into a 100 μm or 200 μm fiber with identical beam parameter product, but if a fiber coupling lens is used for the 100 μm fiber with a 200 μm fiber, the resulting beam parameter product would be 20 mm mrad since the coupling divergence in both cases would be 400 mrad (full angle) but the emission cross section has doubled

This can also be achieved by not directing the entrance angle into the fiber: While the spot remains centered on the fiber core, but the beam is guided at an angle >0°, the beam profile at the exit turns into a donut profile (depending on the coupling angle) if the spot is much smaller than the fiber core size. While “off-axis coupling” leads directly to a donut profile, angle and offset determine the width and diameter of the ring.

There are several options to achieve the functions described above. These will now be described in the following.

FIG. 1 illustrates the use of a parallel transparent substrate 12. Before entering the fiber, the beam is transmitted through one or more parallel transparent substrates 12 (e.g., glass). When the parallel transparent substrate 12 is oriented perpendicular to the beam axis 15, the beam enters the fiber 10 centered after the focusing lens 11. When the parallel transparent substrate 12 is rotated or displaced (arrows), the beam axis has a lateral offset 15′. Alternatively, the parallel transparent substrate 12 may consist of multiple substrates with different thicknesses or refractive indices that are moved within the beam. Still shown in FIG. 1 are deflection mirrors 14, which may be positioned in front of the parallel transparent substrate 12. Spot geometry 13 is shown on the right side of the figure.

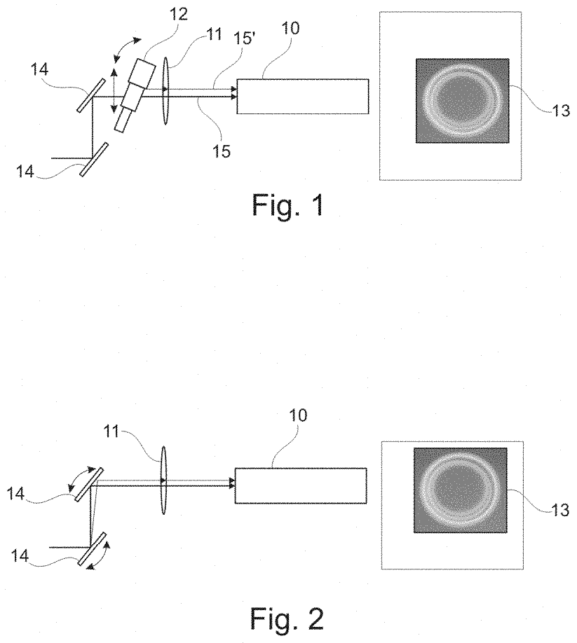

FIG. 2 shows the use of two rotatable (arrows) deflection mirrors 14 in front of the focusing lens 11 when coupling into the fiber 10. This arrangement and rotation of at least one deflection mirror 14 can produce an offset when coupling into the fiber 10 while maintaining an AOI of 0° at the focusing lens 11. This method has the same effect as the arrangement described in FIG. 1. On the right side of the figure, the spot geometry 13 is shown.

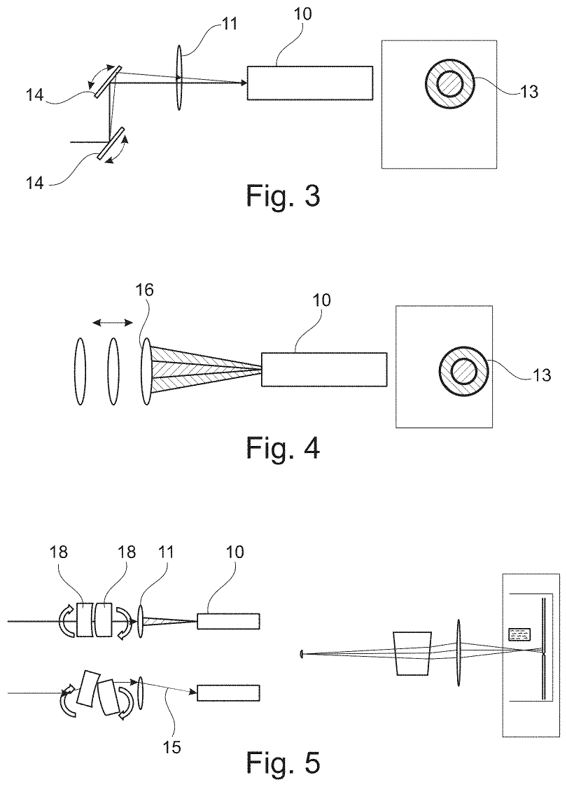

FIG. 3 shows an arrangement as in FIG. 2, but where the deflection mirrors 14 are used to produce a missing point determination, which is, however, centered. This results in a decrease in beam parameter product behind fiber 10. A donut like profile as spot geometry 13 is created when the incoming divergence is much smaller than the acceptance angle of fiber 10 and the spot size is much smaller than the core size. Spot geometry 13 is shown on the right side of the figure.

FIG. 4 shows that using a zoom optic 16 to focus into the fiber produces angular magnification while keeping the spot size constant. This maintains or allows a variable beam parameter product after the fiber 10 while keeping the power distribution after the fiber approximately constant. If the spot size is further reduced, results like those obtained with the arrangement in FIG. 3 can be obtained. In combination with the arrangements shown in FIG. 1 and in FIG. 2, donut profiles with variable beam parameter product are possible. On the right side of the figure, the spot geometry 13 is shown.

FIG. 5 shows the use of a pair of lenses 18 (plano-convex and concave) with identical radius of curvature in front of the focusing lens 11, which can act as an optical adjustable wedge when both lenses of the pair of lenses 18 are displaced relative to each other along their facing surfaces (arrows). When both lenses are parallel to each other, the beam will not pass through the lens system. When the lenses are shifted, the inner curvatures compensate, but the outer planar surfaces form a wedge that leads to a beam shift and thus to an offset coupling of the beam axisl5′. Behind a final focusing lens, there is a pure offset with no misalignment of the beam. The total offset is defined by the angle between the two plane surfaces.

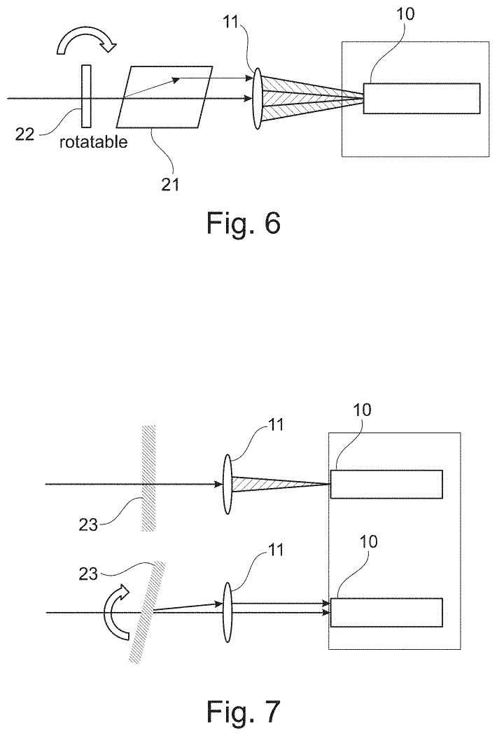

FIG. 6 illustrates the use of birefringence optics 21 in combination with an adjustable half-wave plate (retardation plate): by using a birefringence material (e.g., calcite or YVO4) that makes up birefringence optics 21, unpolarized light is split into two distinct beams, creating an offset between S- and P-polarized beam fractions downstream of the crystal before it is coupled into the fiber 10 downstream of the focusing lens 11. By using a rotatable (about optical axis, arrow) half-wave or quarter-wave plate 22 or an EOM/Pockets cell, the polarization of the light can be rotated; when the polarization is rotated 90°, all the incident light (depending on the polarization degree of the source) is coupled out onto the secondary arm. At any angle between 0° and 90°, only a portion of the incident light is rotated, which means that the amount of light can be adjusted along the extraordinary refractive index of the birefringence crystal. When the crystal dimensions match the fiber properties, this portion of light is in the outer donut.

The use of a rotatable (arrow) dispersive element 23 with a multiple wavelength laser source would widen the beam as a function of the angle of the rotated dispersive element 23 (FIG. 7). In particular, transmission gratings or prisms would not optically affect beam propagation if positioned at 0°. By rotating said element 23, the beam would propagate upward before hitting the focusing lens 11, and the coupling angle into the fiber 10 would be different for each wavelength, increasing the coupling divergence. Using a single wavelength source, this would only be a spread into the diffracted beam and 0th order.

All variations shown in FIG. 1-7 can be placed before or after the focusing lens because the lens converts angles to lateral offset and vice versa.

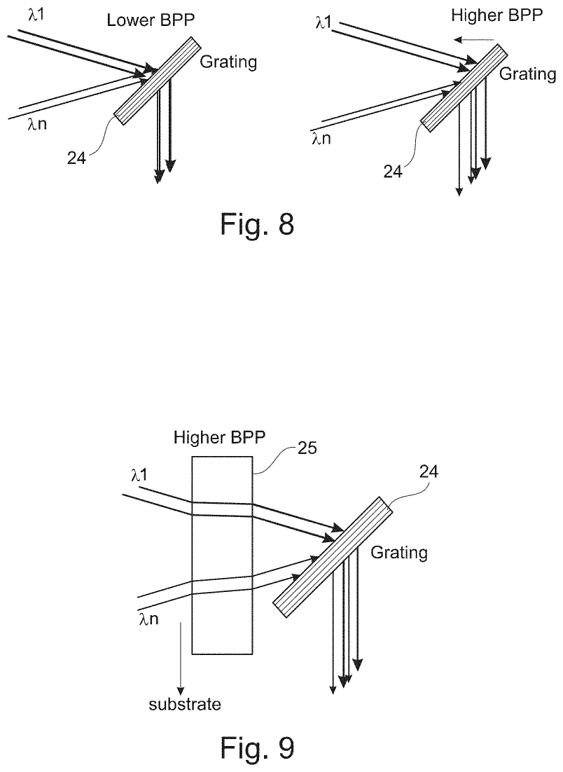

FIG. 8 time the use of multi-wavelength lasers with wavelengths γ1, γn, where gratings 24 are used for wavelength combination and/or stabilization, it may also be possible to move the grating 24 in both directions of the optical axis (arrow) of the system, as this would not affect the diffraction angle, but the offset between the wavelengths. If the same point on the grating is no longer hit, this will result in a higher beam parameter product in free space and will also affect the fiber coupling since the total beam will have a broadening (short wavelength components will be diffracted later/earlier than long wavelengths), at the same time moving the grating may result in an offset of the beam when coupled into the fiber (FIG. 8).

The same effect as described for FIG. 8 is possible when a plane-parallel substrate 25 is introduced into the beam path (FIG. 9). When the plane-parallel substrate 25 is introduced, the beams penetrate the substrate 25 and leave the substrate 25 offset depending on the angle of incidence of the beam. The magnitude of the offset can be affected by the substrate thickness of the plane-parallel substrate 25 with different refractive index. Thus, a set of plane-parallel substrates 25 that can be moved into or out of the beam path can produce individual beam parameter products.

All variations described above can be used in single core fibers, but also in multiple sheath fibers with one or more sheaths. In single core fibers, the behavior of the beam properties after the fiber is as described above. In multiple sheathed fibers, the outer sheaths create a ring around the center. In all parts describing only offset variations, different donuts can be created depending on the fiber structure. In combination with the other methods, different donuts and center spots can be created.

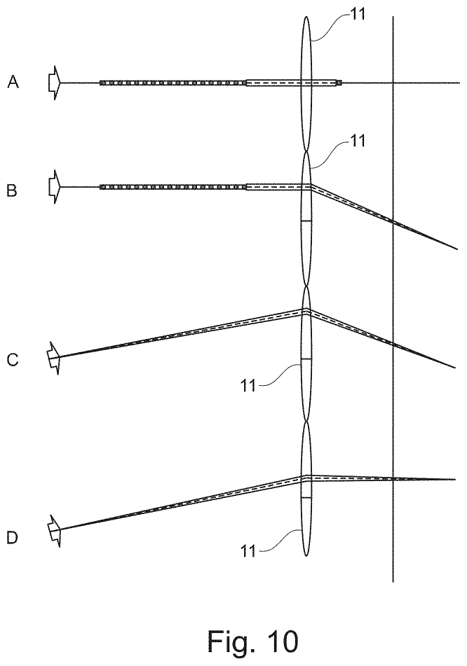

FIG. 10 schematically summarizes the identical effect:
A) A laser with a given divergence is focused on a target;
B) The laser source passes through the focus lens with an offset, resulting in mispointing, but no offset at the target position, potential spot magnification;
C) The laser source points at the focusing lens at an angle different from 0°, creating a pointing error and an offset shift (offset in the focal plane);
D) The laser source is not centered and radiates off-center through the focusing lens, resulting in an offset, but with no mispointing or spot change

The present invention creates a means to adjust the beam parameter product on the fly in a range from the best possible beam parameter product of the laser source to the maximum beam parameter product of the transport fiber (outermost cladding), while continuing to provide core light that is also adjustable.

Current technologies can only use multi-clad fibers and therefore only switch between centered radiation and cladding radiation, especially for high beam parameter products of 30 mm mrad or more.

Currently available concepts are described for fiber lasers and not for diode lasers. With the processes described here and their combination, cutting and welding applications can be performed with the same laser system.

The foregoing description of the preferred embodiment of the invention has been given for the purpose of illustration and description. It is not intended to be exhaustive or to limit the invention precisely to the disclosed form. Modifications and variations are possible in view of the above teachings or may be obtained from practice of the invention. The embodiment has been chosen and described to explain the principles of the invention and its practical application to enable those skilled in the art to use the invention in various embodiments suitable for the particular use intended. It is intended that the scope of the invention be defined by the appended claims and their equivalents. The entirety of each of the foregoing documents is incorporated herein by reference.

### REFERENCE NUMERALS

10 Fiber
11 Focusing lens
12 parallel transparent substrate
13 Spot geometry
14 Deflection mirror
15 Beam axis
16 Zoom optics
18 Pair of lenses
21 Birefringence optics
22 Half-wave or quarter-wave plate
23 dispersive element
24 Grid
25 Substrate

1. A laser material processing apparatus comprising:
laser diodes as a laser source for laser light;
a focusing lens configured to focus the laser light;
a fiber into which the laser light is coupled, wherein a first beam parameter product of the fiber is greater than a second beam parameter product of the laser light incident thereto; and
a substrate configured to create an offset of a beam axis of the laser light.

2. The apparatus of claim 1, wherein the substrate is parallel transparent, comprises multiple substrate portions of different thicknesses arranged side by side, or comprises subunits of different refractive indices.

3. The apparatus of claim 1, comprising at least one rotatable deflection mirror as the substrate or in addition to the substrate.

4. The apparatus of claim 1, wherein the substrate is a zoom optic.

5. The apparatus of claim 1, wherein the substrate is a pair of plano-convex and concave lenses having identical radii of curvature.

6. The apparatus of claim 5, wherein the pair of lenses comprises meniscus lenses.

7. The apparatus of claim 1, wherein the substrate comprises birefringence optics combined with a rotatable halfwave plate.

8. The apparatus of claim 1, wherein the substrate is positioned before or after the focusing lens but before the fiber into which the laser light is coupled.

9. The apparatus of claim 1, wherein the laser source is a multi-wavelength laser; and wherein the substrate is a grating movable in a direction of the beam axis.

10. The apparatus of claim 9, wherein a plane-parallel substrate is additionally disposed in an optical path in front of the grating.

11. A method of increasing coupling divergence to decrease a beam parameter product, comprising the steps of:
generating a laser beam with a diode laser;
focusing the laser beam with a focusing lens;
coupling the laser beam into a fiber; and
changing divergence, spot size, or angle of incidence of the laser beam using a substrate.

12. The method of claim 11, wherein the fiber into which the laser beam is coupled has a higher beam parameter product than the laser light incident thereto.
